(19) United States
(12) Patent Application Publication
(10) Pub. No.: US 2017/0075447 A1
(43) Pub. Date: Mar. 16, 2017

(54) TOUCH-CONTROL DISPLAY PANEL AND TOUCH-CONTROL DISPLAY DEVICE

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventor: Qingcheng ZUO, Shenzhen, Guangdong (CN)

(21) Appl. No.: 14/893,538

(22) PCT Filed: Sep. 18, 2015
(86) PCT No.: PCT/CN2015/089930

§ 371 Date: Nov. 24, 2015

(30) Foreign Application Priority Data
Sep. 10, 2015 (CN) 201510574246.4

(51) Int. Cl. G06F 3/044

(52) U.S. Cl. CPC G06F 3/044

(57) ABSTRACT

The present invention provides a touch-control display panel and a touch-control display device. The touch-control display panel comprises a display module, which comprises a display chip, data lines, scan lines, and pixel units. Each column of the pixel units corresponds to two data lines, and every two rows of the pixel units correspond to one scan line. By making each column of the pixel units correspond to two data lines and every two rows of the pixel units correspond to one scan line, the present invention can shorten the time required for the display scanning and improve the efficiency of the touch-control scanning.

### BACKGROUND OF THE INVENTION

1. Field of the Invention

The present invention relates to a touch-control display technology, and more particularly, to a touch-control display panel and a touch-control display device.

2. Description of Prior Art

As competition in smart phone market grows in depth day by day, this triggers a new round of competition in touch-control display panels. In order to prevent signal interference, the display scanning and the touch-control scanning are separated from each other in the touch-control display panel, that is, the touch-control scanning is performed at the time interval between the display scanning signals corresponding to two adjacent image frames.

As with improvement on resolution of the touch-control display panel, the time required for the display scanning and the charging of a pixel is longer and longer for the touch-control display panel. The time required for the touch-control scanning may not be enough, thereby restricting the development of the touch-control display panel.

Therefore, it is necessary to provide a touch-control display panel and a touch-control display device for solving the problems of conventional skills.

### SUMMARY OF THE INVENTION

The objective of the present invention is to provide a touch-control display panel and a touch-control display device, in which the available time for the touch-control scanning is much longer and the efficiency thereof is much higher, for solving the problem of low efficiency of the touch-control scanning caused by insufficient time for the scanning in the existing touch-control display panel and touch-control display device.

The embodiment of the present invention provides a touch-control display panel, which comprises a display module, said display module comprising: a display chip for generating data signals and scan signals; data lines for transmitting the data signals; scan lines for transmitting the scan signals; and pixel units formed by the data lines and the scan lines interlaced with one another; wherein each column of the pixel units corresponds to two data lines, and every two rows of the pixel units correspond to one scan line; wherein each scan line transmits the scan signals to two adjacent rows of corresponding pixel units, and each data line transmits the data signals to the pixel units of even rows or odd rows in a corresponding column of pixel units.

In the touch-control display panel of the present invention, each one of the scan lines is disposed between two rows of corresponding pixel units.

In the touch-control display panel of the present invention, the touch-control display panel further comprises a touch-control module, said touch-control module comprising: driving lines for transmitting driving signals; sensing lines for generating sensing signals according to touch-control operations and the driving signals; and a touch-control chip for generating the driving signals, and obtaining, according to the sensing signals, the positions corresponding to the touch-control operations.

In the touch-control display panel of the present invention, the touch-control chip generates the driving signals at the time interval between two adjacent image frames displayed by the display module.

The embodiment of the present invention further provides a touch-control display panel, which comprises a display module, said display module comprising: a display chip for generating data signals and scan signals; data lines for transmitting the data signals; scan lines for transmitting the scan signals; and pixel units formed by the data lines and the scan lines interlaced with one another; wherein each column of the pixel units corresponds to two data lines, and every two rows of the pixel units correspond to one scan line.

In the touch-control display panel of the present invention, each scan line transmits the scan signals to two adjacent rows of corresponding pixel units.

In the touch-control display panel of the present invention, each one of the scan lines is disposed between two rows of corresponding pixel units.

In the touch-control display panel of the present invention, each data line transmits the data signals to the pixel units of even rows or odd rows in a corresponding column of pixel units.

In the touch-control display panel of the present invention, the touch-control display panel further comprises a touch-control module, said touch-control module comprising: driving lines for transmitting driving signals; sensing lines for generating sensing signals according to touch-control operations and the driving signals; and a touch-control chip for generating the driving signals, and obtaining, according to the sensing signals, the positions corresponding to the touch-control operations.

In the touch-control display panel of the present invention, the touch-control chip generates the driving signals at the time interval between two adjacent image frames displayed by the display module.

The present invention further provides a touch-control display device, which comprises a backlight source, a display module, and a touch-control module. The display module comprises: a display chip for generating data signals and scan signals; data lines for transmitting the data signals; scan lines for transmitting the scan signals; and pixel units formed by the data lines and the scan lines interlaced with one another; wherein each column of the pixel units corresponds to two data lines, and every two rows of the pixel units correspond to one scan line.

In the touch-control display device of the present invention, each scan line transmits the scan signals to two adjacent rows of corresponding pixel units.

In the touch-control display device of the present invention, each data line transmits the data signals to the pixel units of even rows or odd rows in a corresponding column of pixel units.

In the touch-control display device of the present invention, each one of the scan lines is disposed between two rows of corresponding pixel units.

In the touch-control display device of the present invention, the touch-control module further comprises: driving lines for transmitting driving signals; sensing lines for generating sensing signals according to touch-control operations and the driving signals; and a touch-control chip for generating the driving signals, and obtaining, according to the sensing signals, the positions corresponding to the touch-control operations.

In the touch-control display device of the present invention, the touch-control chip generates the driving signals at the time interval between two adjacent image frames displayed by the display module.

By making each column of the pixel units correspond to two data lines and every two rows of the pixel units correspond to one scan line, the touch-control display panel and the touch-control display device of the present invention, as compared to the existing touch-control display panel and touch-control display device, can shorten the time required for the display scanning and improve the efficiency of the touch-control scanning, thereby solving the problem of low efficiency of the touch-control scanning caused by insufficient time for the scanning in the existing touch-control display panel and touch-control display device.

### BRIEF DESCRIPTION OF THE DRAWINGS

To make above content of the present invention more easily understood, it will be described in details by using preferred embodiments in conjunction with the appending drawings.

FIG. 1 is a schematic structural diagram showing a touch-control display panel in accordance with a preferred embodiment of the present invention.

FIG. 2 is a schematic structural diagram showing a display module of the touch-control display panel in accordance with a preferred embodiment of the present invention.

FIG. 3 is a schematic structural diagram showing a touch-control module of the touch-control display panel in accordance with a preferred embodiment of the present invention.

FIG. 4 shows a driving timing for the display module and the touch-control module of the touch-control display panel in accordance with a preferred embodiment of the present invention.

### DETAILED DESCRIPTION OF THE PREFERRED EMBODIMENTS

The following descriptions for the respective embodiments are specific embodiments capable of being implemented for illustrations of the present invention with referring to appending figures. In descripting the present invention, spatially relative terms such as “upper”, “lower”, “front”, “back”, “left”, “right”, “inner”, “outer”, “lateral”, and the like, may be used herein for ease of description as illustrated in the figures. Therefore, the spatially relative terms used herein are intended to illustrate the present invention for ease of understanding, but are not intended to limit the present invention. In the appending drawings, units with similar structures are indicated by the same reference numbers.

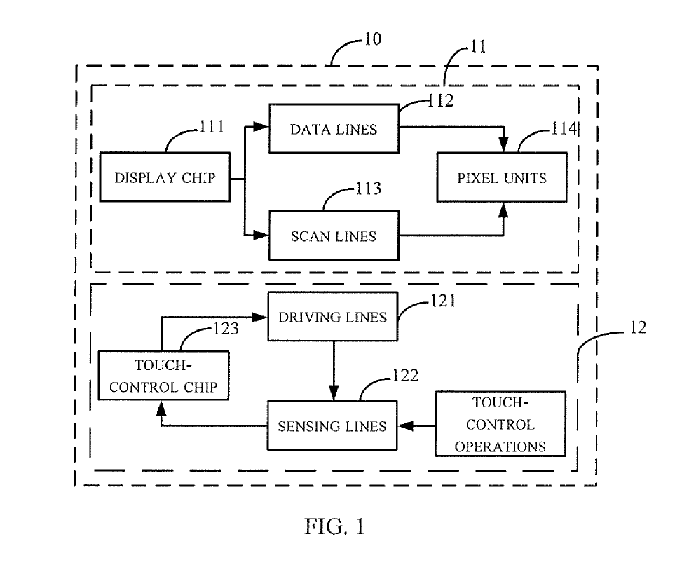

Please refer to FIG. 1, which is a schematic structural diagram showing a touch-control display panel in accordance with a preferred embodiment of the present invention. The touch-control display panel 10 comprises a display module 11 and a touch-control module 12. The display module 11 comprises a display chip 111, data lines 112, scan lines 113, and pixel units 114. The data lines 112 are used to transmit data signals; the scan lines 113 are used to transmit scan signals; and the pixel units 114 are formed by the data lines 112 and the scan lines 113 interlaced with one another. Each column of the pixel units 114 corresponds to two data lines 112, and every two rows of the pixel units 114 correspond to one scan line 113.

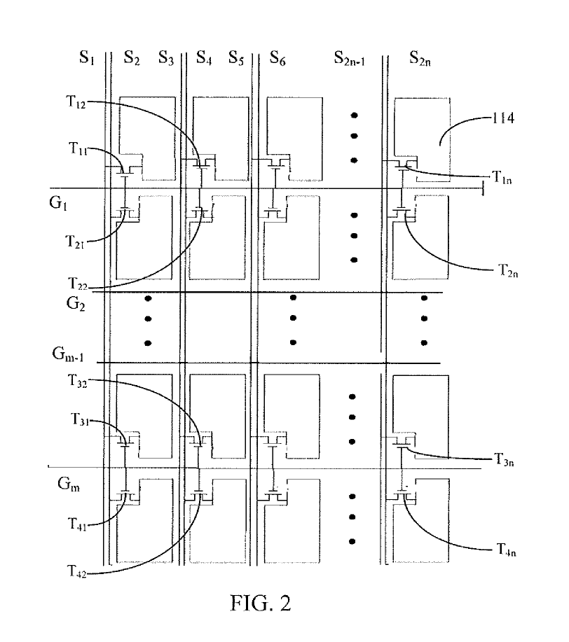

Please refer to FIG. 2, which is a schematic structural diagram showing a display module of the touch-control display panel in accordance with a preferred embodiment of the present invention. As can be seen from the figure, each scan line 113, such as one of the scan signal G1 to the scan line Gm, transmits scan signals to two adjacent rows of corresponding pixel units 114. Each one of the scan lines is disposed between two rows of the corresponding pixel units 114. Such a structure is simple and is able to be better to transmit scan signals. Each data line 112, such as one of the data line S1 to the data line S2n, transmits data signals to pixel units of even rows or odd rows in a corresponding column of pixel units. Of course, it can be arranged, according to the demands, any one data line to transmit the data signals to a part of pixel units in a corresponding column.

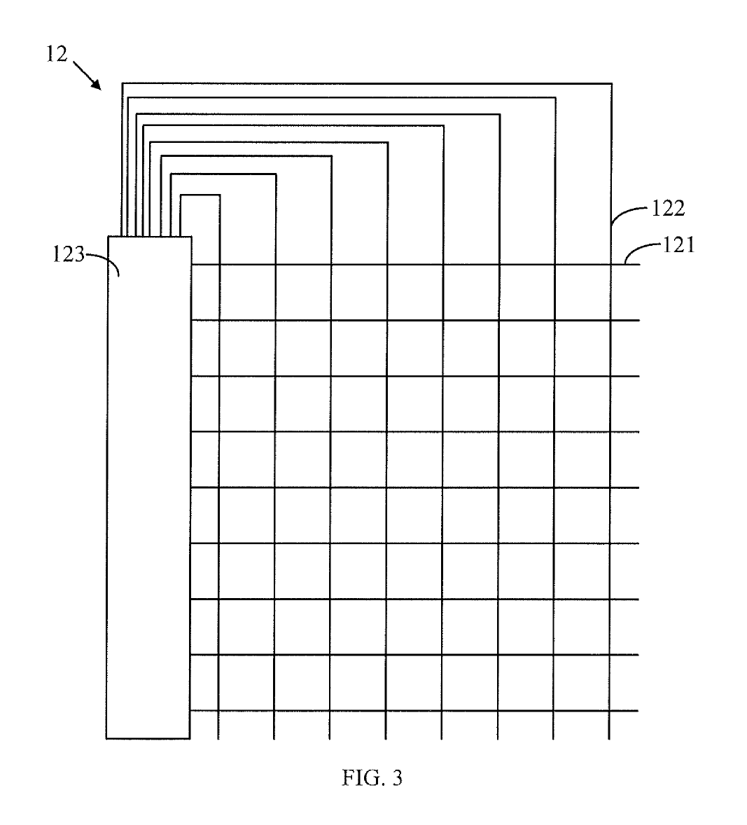

Please refer to FIGS. 1 and 3. FIG. 3 is a schematic structural diagram showing a touch-control module of the touch-control display panel in accordance with a preferred embodiment of the present invention. The touch-control module 12 comprises driving lines 121, sensing lines 122, and a touch-control chip 123. The driving lines 121 are used to transmit driving signals such as the driving signals TX1 to TXi; the sensing lines 122 are used to generate sensing signals according to touch-control operations and the driving signals; and the touch-control chip 123 is used to generate the driving signals, and obtain, according to the sensing signals, the positions corresponding to the touch-control operations.

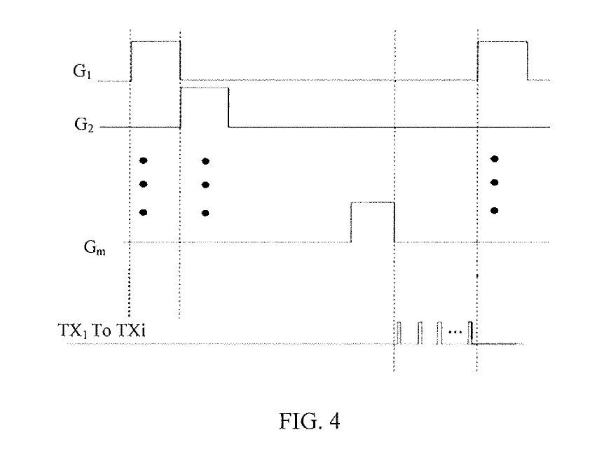

The principles of the touch-control display panel of the present preferred embodiment will be detailedly described below with reference to FIGS. 2 and 4. FIG. 4 shows a driving timing for the display module and the touch-control module of the touch-control display panel in accordance with a preferred embodiment of the present invention.

In the process of image driving, at the beginning, the scan line G1 outputs a high voltage level and all the other scan lines output a low voltage level. Meanwhile, the transistors T11, T12, . . . , and T1n and the transistors T21, T22, . . . , and T2n are turned on. In such a manner, the data lines S1 to S2n respectively provide data signals to the first row and the second row of the pixel units. That is, the data line S1 provides a data signal to the pixel unit in the first row and the first column; the data line S2 provides a data signal to the pixel unit in the second row and the first column; the data line S3 provides a data signal to the pixel unit in the first row and the second column; the data line S4 provides a data signal to the pixel unit in the second row and the second column; and so on, that is, the data line S2n−1 provides a data signal to the pixel unit in the first row and the nth column, and the data line S2n provides a data signal to the pixel unit in the second row and the nth column.

After that, the scan lines G2 to Gm−1 sequentially output the high voltage level, and meanwhile all the other scan lines output the low voltage level. In such a manner, the data signals are provided to the pixel units of the 3rd row to the (2m−2)th row.

In the end, the scan line Gm outputs the high voltage level and all the other scan lines output the low voltage level. The transistors T31, T32, . . . , and T3n and the transistors T41, T42, . . . , and T4n are turned on. In such a manner, the data lines S1 to S2n respectively provide data signals to the (2m−1)th row and the (2m)th row of the pixel units. That is, the data line S1 provides a data signal to the pixel unit in the (2m−1)th row and the first column; the data line S2 provides a data signal to the pixel unit in the (2m)th row and the first column; the data line S3 provides a data signal to the pixel unit in the (2m−1)th row and the second column; the data line S4 provides a data signal to the pixel unit in the (2m)th row and the second column; and so on, that is, the data line S2n−1 provides a data signal to the pixel unit in the (2m−1)th row and the nth column, and the data line S2n provides a data signal to the pixel unit in the (2m)th row and the nth column.

When the high voltage level has been sequentially outputted by all of the scan lines 113, the touch-control display panel 10 proceed with the touch-control driving after the driving for a current image frame is finished and before the driving for a next image frame starts. That is, the touch-control chip 123 generates the driving signals TX1 to TXi at the time interval between two adjacent image frames displayed by the display module 11. In such a way, the touch-control chip 123 generates the driving signals TX1 to TXi and transmits the driving signals to all of the driving lines 121. Meanwhile, the sensing lines 122 generate the sensing signals according to the driving signals and the touch-control operations, and transmit the sensing signals to the touch-control chip 123. In the end, the touch-control chip 123 obtains, according to the sensing signals, the positions corresponding to the touch-control operations.

In the touch-control display panel 10 in accordance with the present preferred embodiment of the present invention, the number of the data lines 112 is increased while the number of the scan lines 113 is decreased, that is, the number of the data lines 112 after improved is twice the number of the data lines before improved, and the number of the scan lines 113 after improved is half as much as the number of scan lines before improved. In such a way, the charging time of the pixel unit 114 is reduced to half the normal charging time in the process of image driving, thereby there has more time for the touch-control driving, and the number of scanning in the touch-control driving can be effectively increased and the precision of the scanning in the touch-control driving can be effectively improved, that is, there has sufficient time to proceed with touch-control scanning for many times or to proceed with the touch-control scanning in high precision.

The present invention further provides a touch-control display device. The touch-control display device comprises a backlight source, a display module, and a touch-control module. The display module comprises a display chip, data lines, scan lines, and pixel units. The display chip is used to generate data signals and scan signals. The data lines are used to transmit the data signals; the scan lines are used to transmit the scan signals; and the pixel units are formed by the data lines and the scan lines interlaced with one another. The touch-control module comprises driving lines, sensing lines, and a touch-control chip. The driving lines are used to transmit driving signals; the sensing lines are used to generate sensing signals according to touch-control operations and the driving signals; and the touch-control chip is used to generate the driving signals, and obtain, according to the sensing signals, the positions corresponding to the touch-control operations.

Each column of the pixel units corresponds to two data lines, and every two rows of the pixel units correspond to one scan line.

Preferably, each scan line transmits the scan signals to two adjacent rows of corresponding pixel units.

Preferably, each one of the scan lines is disposed between two rows of the corresponding pixel units.

Preferably, each data line transmits the data signals to pixel units of even rows or odd rows in a corresponding column of pixel units.

Preferably, the touch-control chip generates the driving signals at the time interval between two adjacent image frames displayed by the display module.

The principles of the touch-control display device in accordance with the present invention is the same as or similar to that of the afore-described touch-control display panel of the preferred embodiment, and thus please refer to the related descriptions of the afore-described touch-control display panel of the preferred embodiment.

By making each column of the pixel units correspond to two data lines and every two rows of the pixel units correspond to one scan line, the touch-control display panel and the touch-control display device of the present invention can shorten the time required for the display scanning and improve the efficiency of the touch-control scanning, thereby solving the problem of low efficiency of the touch-control scanning caused by insufficient time for the scanning in the existing touch-control display panel and touch-control display device.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A touch-control display panel, which comprises a display module, said display module comprising:
a display chip for generating data signals and scan signals;
data lines for transmitting the data signals;
scan lines for transmitting the scan signals; and
pixel units formed by the data lines and the scan lines interlaced with one another;
wherein each column of the pixel units corresponds to two data lines, and every two rows of the pixel units correspond to one scan line;
wherein each scan line transmits the scan signals to two adjacent rows of corresponding pixel units, and each data line transmits the data signals to the pixel units of even rows or odd rows in a corresponding column of pixel units.

2. The touch-control display panel according to claim 1, wherein each one of the scan lines is disposed between two rows of corresponding pixel units.

3. The touch-control display panel according to claim 1, further comprising a touch-control module, said touch-control module comprising:
driving lines for transmitting driving signals;
sensing lines for generating sensing signals according to touch-control operations and the driving signals; and
a touch-control chip for generating the driving signals, and obtaining, according to the sensing signals, the positions corresponding to the touch-control operations.

4. The touch-control display panel according to claim 3, wherein the touch-control chip generates the driving signals at the time interval between two adjacent image frames displayed by the display module.

5. A touch-control display panel, which comprises a display module, said display module comprising:
a display chip for generating data signals and scan signals;
data lines for transmitting the data signals;
scan lines for transmitting the scan signals; and
pixel units formed by the data lines and the scan lines interlaced with one another;
wherein each column of the pixel units corresponds to two data lines, and every two rows of the pixel units correspond to one scan line.

6. The touch-control display panel according to claim 5, wherein each scan line transmits the scan signals to two adjacent rows of corresponding pixel units.

7. The touch-control display panel according to claim 6, wherein each one of the scan lines is disposed between two rows of corresponding pixel units.

8. The touch-control display panel according to claim 5, wherein each data line transmits the data signals to the pixel units of even rows or odd rows in a corresponding column of pixel units.

9. The touch-control display panel according to claim 5, further comprising a touch-control module, said touch-control module comprising:
driving lines for transmitting driving signals;
sensing lines for generating sensing signals according to touch-control operations and the driving signals; and
a touch-control chip for generating the driving signals, and obtaining, according to the sensing signals, the positions corresponding to the touch-control operations.

10. The touch-control display panel according to claim 9, wherein the touch-control chip generates the driving signals at the time interval between two adjacent image frames displayed by the display module.

11. A touch-control display device, which comprises a backlight source, a display module, and a touch-control module, said display module comprising:
a display chip for generating data signals and scan signals;
data lines for transmitting the data signals;
scan lines for transmitting the scan signals; and
pixel units formed by the data lines and the scan lines interlaced with one another;
wherein each column of the pixel units corresponds to two data lines, and every two rows of the pixel units correspond to one scan line.

12. The touch-control display device according to claim 11, wherein each scan line transmits the scan signals to two adjacent rows of corresponding pixel units.

13. The touch-control display device according to claim 11, wherein each data line transmits the data signals to the pixel units of even rows or odd rows in a corresponding column of pixel units.

14. The touch-control display device according to claim 11, wherein each one of the scan lines is disposed between two rows of corresponding pixel units.

15. The touch-control device panel according to claim 11, wherein the touch-control module comprises:
driving lines for transmitting driving signals;
sensing lines for generating sensing signals according to touch-control operations and the driving signals; and
a touch-control chip for generating the driving signals, and obtaining, according to the sensing signals, the positions corresponding to the touch-control operations.

16. The touch-control display device according to claim 15, wherein the touch-control chip generates the driving signals at the time interval between two adjacent image frames displayed by the display module.
